(19) United States
(12) Patent Application Publication
(10) Pub. No.: US 2009/0240859 A1
(43) Pub. Date: Sep. 24, 2009

(54) AUTOMATIC ADDRESS SETTING SYSTEM

(75) Inventor: MING-CHIH HSIEH, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/122,744

(22) Filed: May 19, 2008

(30) Foreign Application Priority Data
Mar. 21, 2008 (CN) 200810300659.3

(51) Int. Cl. G06F 13/18

(52) U.S. Cl. 710/110

(57) ABSTRACT

An automatic address setting system and method includes a master device, first and second slave devices. Each slave device includes a peripheral interface controller (PIC), a counter, and a pulse generator. When the first slave device is connected to the master device, the pulse generator generates a first pulse signal to the master device and the corresponding counter. The counter sends an address signal to the corresponding PIC as an identification address of the PIC. When the second slave device is subsequently connected to the master device, the pulse generator generates a second pulse signal to the master device, and the counters of the first and second slave devices. The counter sends an address signal to the corresponding PIC as an identification address of the PIC. The counter of the first slave device changes the identification address of the first slave device.

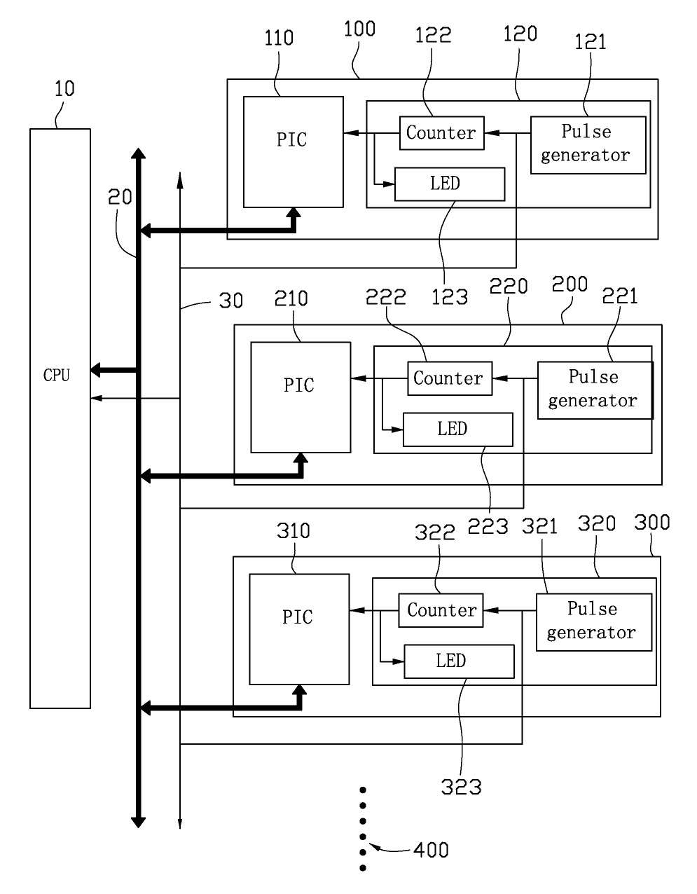

### BACKGROUND

1. Field of the Invention

The present invention relates to an automatic address setting system.

2. Description of Related Art

In communication between a master device and slave devices, the master device transmits data to a slave device by using a number of the slave device. A slave device receives data corresponding to its own number and transmits response data to the master device.

In earlier control systems, the process of setting addresses is achieved through the use of two rotary address switches. The two rotary address switches use a decimal format to set the addresses of the slave devices of the control system. When the control system includes up to several thousand slave devices, setting the addresses of the slave devices is time consuming, and the possibility of mistakes is increased.

What is desired, therefore, is to provide an automatic address setting system for automatically setting respective identification numbers for a plurality of slave devices constituting a network.

### SUMMARY

An exemplary automatic address setting system includes a master device, a first slave device, and a second slave device. Each of the slave devices includes a peripheral interface controller (PIC), a counter, and a pulse generator. The counter is connected to the corresponding PIC. The pulse generator is connected to the corresponding counter. When the first slave device is connected to the master device, the pulse generator of the first slave device generates a first pulse signal to the master device and the counter of the first slave device. The counter of the first slave device receives the first pulse signal and sends an address signal to the PIC of the first slave device as an identification address of the first slave device. When the second slave device is subsequently connected to the master device, the pulse generator of the second slave device generates a second pulse signal to the master device, and the counters of the first and second slave devices. The counter of the second slave device receives the second pulse signal and sends an address signal to the PIC of the second slave device as an identification address of the second slave device. At the same time, the counter of the first slave device changes the identification address of the PIC of the first slave device.

Other advantages and novel features of the present invention will become more apparent from the following detailed description of exemplary embodiment when taken in conjunction with the accompanying drawing, in which:

### BRIEF DESCRIPTION OF THE DRAWINGS

The drawing is a schematic diagram of an automatic address setting system in accordance with an exemplary embodiment of the present invention.

### DETAILED DESCRIPTION

Referring to the drawing, an automatic address setting system in accordance with an exemplary embodiment of the present invention includes a master device 10, such as a central processor unit, and a plurality of slave devices 100, 200, 300, etc. Each slave device includes a peripheral interface controller (PIC) and an identification address startup apparatus. The identification address startup apparatus includes a pulse generator, a counter, and a plurality of light-emitting diodes (LEDs). The master device 10 is connected to the PIC of each slave device through a bus 20, and connected to the pulse generator of each slave device through a signal line 30. The pulse generator of each slave device is connected to the corresponding counter. The counter is connected to the corresponding PIC and the corresponding LED.

In this embodiment, the slave device 100 includes a PIC 110 and an identification address startup apparatus 120. The identification address startup apparatus 120 includes a pulse generator 121, a counter 122, and a set of LEDs 123. The slave device 200 includes a PIC 210 and an identification address startup apparatus 220. The identification address startup apparatus 220 includes a pulse generator 221, a counter 222, and a set of LEDs 223. The slave device 300 includes a PIC 310 and an identification address startup apparatus 320. The identification address startup apparatus 320 includes a pulse generator 321, a counter 322, and a set of LEDs 323. The elements and structures of the other slave devices are the same as the slave devices 100, 200, and 300.

When the slave device 100 is connected to the master device 10, the pulse generator 121 of the slave device 100 sends a pulse signal to the master device 10 and the counter 122 of the slave device 100. The master device 10 receives the pulse signal and confirms a slave device is connected. The counter 122 receives the pulse signal, and then sends an address signal to the PIC 110 of the slave device 100. The address signal acts as an identification address of the PIC 110. The set of LEDs 123 respectively receives the bits of the address signal. The number of LEDs in the set of LEDs is equal to the bits of the address signal.

When the slave device 200 is connected to the master device 10, the pulse generator 221 of the slave device 200 sends a pulse signal to the master device 10, the counter 222 of the slave device 200, and the counter 122 of the slave device 100. The master device 10 receives the pulse signal and confirms a slave device is connected. The counter 222 receives the pulse signal, and then sends an address signal to the PIC 210. The address signal acts as an identification address of the PIC 210. The LED 223 displays the address signal. At the same time, the pulse signal from the pulse generator 221 of the slave device 200 is sent to the counter 122 of the slave device 100. The address signal from the counter 122 of the slave device 100 is increased by one, and acts as the identification address of the PIC 110. Therefore, the identification addresses of the slave devices 100 and 200 are different.

When the slave device 300 is connected to the master device 10, the pulse generator 321 of the slave device 300 sends a pulse signal to the master device 10, the counter 322 of the slave device 300, the counter 222 of the slave device 200, and the counter 122 of the slave device 100. The master device 10 receives the pulse signal and confirms a slave device is connected. The counter 322 of the slave device 300 receives the pulse signal, and then sends an address signal to the PIC 310. The address signal acts as an identification address of the PIC 310. The LED 323 displays the address signal. At the same time, the pulse signal from the pulse generator 321 of the slave device 300 is sent to the counter 122 of the slave device 100 and the counter 222 of the slave device 200. The address signal from the counter 122 of the slave device 100 is, once again, increased by one and acts as the identification address of the PIC 110. The address signal from the counter 222 of the slave device 200 is increased by one and acts as the identification address of the PIC 210. Therefore, the identification addresses of the slave devices 100, 200, and 300 are different. The master device 10 according to a value of the pulse signal selects an identification address of a corresponding slave device, and communicates with the slave device. Other slave devices are managed and behave in the same manner.

When a slave device is connected to the master device 10, power from the master device 10 is provided to the slave device, and the pulse generator of the slave device generates a pulse signal. When the slave device 100 is initially connected to the master device 10, the counter 122 of the slave device 100 sends an address ID=000 as an identification address of the slave device 100. The master device 10 receives the count of the pulse signal K=1. When the slave device 200 is subsequently connected to the master device 10, the counter 222 of the slave device 200 sends an address ID=000 as an identification address of the slave device 200. The master device 10 receives the count of the pulse signal K=2. At the same time, the identification address of the slave device 100 is changed to ID=001 as the identification address of the slave device 100. When the slave device 300 is connected to the master device 10, the counter 322 of the slave device 300 sends an address ID=000 as an identification address of the slave device 300. The master device 10 receives the count of the pulse signal K=3. At the same time, the identification address of the slave device 200 is changed to ID=001 as the identification address of the slave device 200. The identification address of the slave device 100 is changed to ID=010 as the identification address of the slave device 100.

In this embodiment, the slave devices are connected to the master device 10 in sequence. The pulse generator of each slave device sends a pulse signal to the corresponding counter. The counter receives the pulse signal, and then generates an address signal to the corresponding PIC. The address signal acts as an identification address of the PIC. When the second slave device is connected to the master device 10, it is managed and behaves the same as the first slave device. At the same time, the identification address of the first slave device is increased by one and acts as the identification address of the first slave device. The master device 10, according to a value of the pulse signal, selects an identification address of a corresponding slave device, and communicates with the slave device. The automatic address setting system is simple and cost-effective. The system can be used with vast numbers of slave devices as indicated by 400.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An automatic address setting system comprising:
a master device, a first slave device, and a second slave device;
wherein all of the slave devices comprise a peripheral interface controller (PIC), a counter connected to the PIC, and a pulse generator connected to the counter;
wherein when the first slave device is connected to the master device; the pulse generator of the first slave device is capable of generating a first pulse signal to both the master device and the counter of the first slave device; the counter of the first slave device is capable of receiving the first pulse signal and sending a first address signal to the PIC of the first slave device; when the second slave device is subsequently connected to the master device, the pulse generator of the second slave device is capable of generating a second pulse signal to the master device and the counters of the first and second slave devices; the counter of the second slave device is capable of receiving the second pulse signal and sending a second address signal to the PIC of the second slave device; the counter of the first slave device is capable of changing the identification address of the PIC of the first slave device in response to the second pulse signal.

2. The automatic address setting system as claimed in claim 1, wherein the master device is a central processing unit.

3. The automatic address setting system as claimed in claim 1, wherein each of the slave devices further comprises a set of light-emitting diodes (LEDs), each set of the LEDs receives the address signal from the counter and displays the address signal and the number of the LEDs in each set is equal to the bits of the address signal.

4. The automatic address setting system as claimed in claim 1, wherein the counter of the first slave device is capable of changing the identification address of the PIC of the first slave device by adding one to the identification address.

5. An automatic address setting system comprising:
a master device;
a first slave device comprising a first peripheral interface controller (PIC), a first counter connected to the first PIC, and a first pulse generator connected to the first counter; and
a second slave device comprising a second peripheral interface controller (PIC), a second counter connected to the second PIC, and a second pulse generator connected to the second counter;
wherein the first slave device is connected to the master device, the first pulse generator is capable of generating a first pulse signal and sending the first pulse signal to the master device and the first counter, the first counter is capable of sending a first address signal to the first PIC;
the second slave device is connected to the master device, the second pulse generator is capable of generating a second pulse signal and sending the second pulse signal to the master device, the second counter and the first counter; and
the first counter is capable of receiving the second pulse signal and sending an address change signal to the first PIC.

6. The automatic address setting system as claimed in claim 5, wherein the master device is a central processing unit.

7. The automatic address setting system as claimed in claim 5, wherein each of the slave devices further comprises a set of light-emitting diodes (LEDs), each set of the LEDs receives the address signal from the counter and displays the address signal, and the number of the LEDs in each set is equal to the bits of the address signal.

8. The automatic address setting system as claimed in claim 5, wherein the address change signal comprises of the first address signal plus one integer.

9. The automatic address setting system as claimed in claim 5, the system further comprising one or more additional slave devices and wherein the first counter is adapted to receive address change signals from the one or more additional salve devices.

10. The automatic address setting system as claimed in claim 9, wherein the second counter is adapted to receive address change signals from the one or more additional slave devices.

11. A method for automatically setting an address, the method comprising of:
providing:
a master device;
a first slave device comprising a first peripheral interface controller (PIC), a first counter connected to the first PIC, and a first pulse generator connected to the first counter; and
a second slave device comprising a second peripheral interface controller (PIC), a second counter connected to the second PIC, and a second pulse generator connected to the second counter;
wherein the first slave device is connected to the master device, the first pulse generator generates a first pulse signal and sends the first pulse signal to the master device and the first counter, the first counter sends a first address signal to the first PIC;
the second slave device is connected to the master device, the second pulse generator generates a second pulse signal and sends the second pulse signal to the master device, the second counter and the first counter; and
the first counter receives the second signal and sends an address change signal to the first PIC.

12. The method as claimed in claim 11, wherein the master device is a central processing unit.

13. The method as claimed in claim 11, wherein the first and second slave devices each comprise a set of light-emitting diodes (LEDs), each set of the LEDs receives the address signal from the counter and displays the address signal and the number of the LEDs in each set is equal to the bits of the address signal.

14. The method as claimed in claim 11, wherein the counter adds one integer to the first address signal to create the address change signal.

15. The method as claimed in claim 11, the method further comprising of providing one or more additional slave devices and wherein the first counter receives address change signals from the one or more additional salve devices.

16. The method as claimed in claim 15, wherein the second counter receives address change signals from the one or more additional slave devices.
